(19) United States
(12) Patent Application Publication
(10) Pub. No.: US 2025/0025014 A1
(43) Pub. Date: Jan. 23, 2025

(54) MULTICHANNEL DISPENSER ASSEMBLY

(71) Applicant: Haier US Appliance Solutions, Inc., Wilmington, DE (US)

(72) Inventors: Ravi Patel, Louisville, KY (US); Reagan Murphy, Louisville, KY (US)

(21) Appl. No.: 18/356,495

(22) Filed: Jul. 21, 2023

(51) Int. Cl. A47L 15/42; A47L 15/44; F16K 3/08

(52) U.S. Cl. CPC A47L 15/4217; A47L 15/4418; F16K 3/085

(57) ABSTRACT

The present disclosure is directed to a dispenser assembly for an appliance. The dispenser assembly includes a housing, a rotatable disk, and an actuator. The housing has a plurality of inlets and an outlet. The rotatable disk is positioned within the housing. The rotatable disk includes an aperture for being selectively aligned with one of the plurality of inlets to provide a flow path between one of the plurality of inlets and the outlet of the housing. Further, the actuator is mechanically coupled to the rotatable disk for driving rotation of the rotatable disk about an axis to align the aperture of the rotatable disk with one of the plurality of inlets.

### FIELD OF THE INVENTION

The present invention relates generally to appliances, and more specifically to a multichannel dispenser assembly for an appliance.

### BACKGROUND OF THE INVENTION

Common appliances may include dishwashers, washing machines, dryers, and other appliances. Certain appliances, such as washing machines and dishwashers generally include a tub that defines a wash chamber and a pump for directing fluids from a fluid reservoir into the wash chamber during washing operations.

Furthermore, dishwashers generally include a detergent dispenser for dispensing detergent into the wash chamber. Traditionally, such dispensers either mix the fluids or maintain distinct channels. Mixing the fluids is undesirable in some cases, such a dishwasher cycle where specific liquids need to be dispensed at specific times. Further, maintaining distinct channels can be undesirable because separate control devices are required for all channels, thereby adding complexity.

Accordingly, a dispenser assembly for selectively dispensing separate wash fluids would be welcomed in the art. Thus, the present disclosure is directed to a multichannel dispenser assembly that provides selective control of multiple fluids.

### BRIEF DESCRIPTION OF THE INVENTION

Aspects and advantages of the invention will be set forth in part in the following description, or may be obvious from the description, or may be learned through practice of the invention.

In an aspect, the present disclosure is directed to a dispenser assembly for an appliance. The dispenser assembly includes a housing, a rotatable disk, and an actuator. The housing has a plurality of inlets and an outlet. The rotatable disk is positioned within the housing. The rotatable disk includes an aperture for being selectively aligned with one of the plurality of inlets to provide a flow path between one of the plurality of inlets and the outlet of the housing. Further, the actuator is mechanically coupled to the rotatable disk for driving rotation of the rotatable disk about an axis to align the aperture of the rotatable disk with one of the plurality of inlets.

In another aspect, the present disclosure is directed to a dishwashing appliance. The dishwashing appliance includes a wash chamber, a door, a fluid reservoir, a pump, and a dispenser assembly. The wash chamber is configured for the receipt of articles for washing, and the door is configured for selectively opening and closing the wash chamber. The fluid reservoir contains a plurality of fluids. The pump directs the plurality of fluids to flow from the fluid reservoir to the wash chamber. The dispenser assembly includes a housing, a rotatable disk, an actuator, and a dispenser. The housing has a plurality of inlets and an outlet. The rotatable disk is positioned within the housing. The rotatable disk comprises an aperture for being selectively aligned with one of the plurality of inlets to provide a flow path between one of the plurality of inlets and the outlet. The actuator is mechanically coupled to the rotatable disk for driving rotation of the rotatable disk about an axis to align the aperture of the rotatable disk with one of the plurality of inlets. Further, the dispenser is connected to the outlet for dispensing one of the plurality of different fluids into the appliance at a time.

In another aspect, the present disclosure is directed to a method for operating a dishwashing appliance comprising a dispenser assembly. The dispenser assembly includes a housing having a plurality of inlets and an outlet, a rotatable disk positioned within the housing, and an actuator mechanically coupled to the rotatable disk for driving rotation of the rotatable disk. The method includes rotating, via the actuator, the rotatable disk about an axis to align an aperture of the rotatable disk with an inlet of the plurality of inlets. In addition, the method includes directing, via a pump of the dishwashing appliance, a fluid of a plurality of fluids into the housing of the dispenser assembly. The dispense assembly is fluidly coupled with a fluid reservoir containing a plurality of different fluids via a plurality of conduits coupled to the plurality of inlets. The method also includes dispensing, via a dispenser of the dishwashing appliance, the fluid from the housing of the dispenser assembly into the dishwashing appliance. The outlet of the dispenser assembly is connected to the dispenser. Further, the method includes rotating, via the actuator, the rotatable disk about the axis to align the aperture of the rotatable disk with a different inlet of the plurality of inlets to dispense a different fluid of the plurality of fluids.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a dishwashing appliance in accordance with an embodiment of the present disclosure;

FIG. 2 provides a side, cross-sectional view of the dishwashing appliance of FIG. 1;

FIG. 3 provides a perspective view of a multichannel dispenser assembly in accordance with an embodiment of the present disclosure;

FIG. 4 provides a cross sectional view of the multichannel dispenser assembly of FIG. 3 along line 4-4;

FIG. 5 provides an exploded view of the multichannel dispenser assembly of FIG. 3;

FIGS. 6A-6B provide alternative embodiments of a seal for a multichannel dispenser assembly in accordance with an embodiment of the present disclosure;

FIGS. 7A-7B provide cross-sectional views of the multichannel dispenser assembly of FIG. 3 in different positions;

FIGS. 8A-8B provide perspective views of further embodiments of a rotatable disk of a multichannel dispenser assembly in accordance with an embodiment of the present disclosure; and

FIG. 9 provides a flow diagram of a method for operating a multichannel dispenser assembly in accordance with an embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The term “article” may refer to, but need not be limited to, dishes, pots, pans, silverware, and other cooking utensils and items that can be cleaned in a dishwashing appliance; garments, fabrics, textiles, linens, clothing and other clothing articles and items that can be cleaned in a laundry appliance. In The term “fluid” refers to a liquid used for washing and/or rinsing the articles and is typically made up of water that may include additives such as detergent or other treatments, such as liquid detergent, powder detergent, bleach, and softener. The terms “first” and “second” may be used interchangeably to distinguish one component from another and are not intended to signify the location or importance of the individual components.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

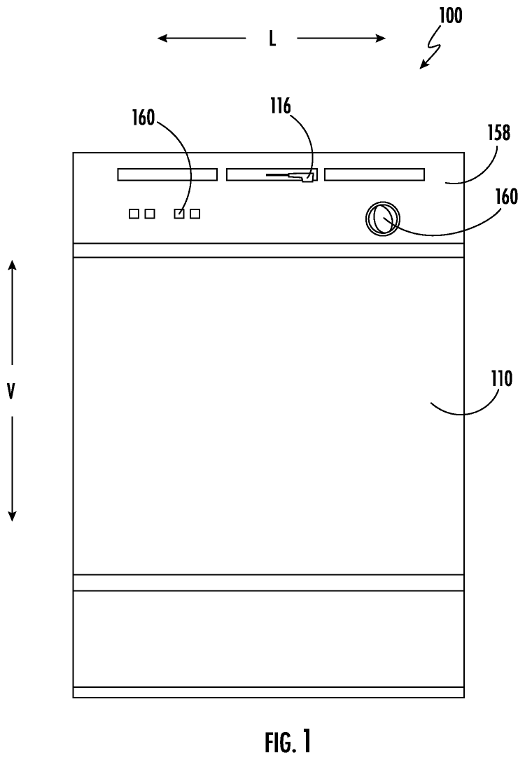

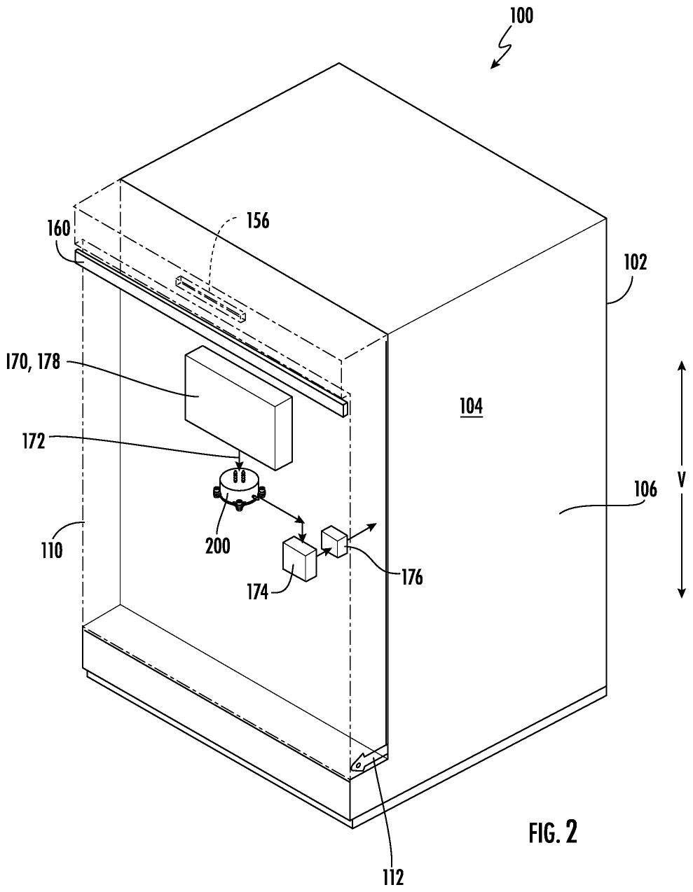

Referring now to the drawings, FIGS. 1 and 2 illustrate a front view of an appliance that may be configured in accordance with aspects of the present disclosure. For the particular embodiment of FIGS. 1 and 2, the appliance is a dishwasher appliance 100. As shown particularly in FIG. 2, the dishwasher appliance 100 includes a cabinet 102 having a tub 104 therein that defines a wash chamber 106 for the receipt of articles for washing. The tub 104 includes a front opening (not shown) and a door 110 for selectively opening and closing the wash chamber 106. As shown, the door 110 may be hinged to the wash chamber 106 for movement between a closed position (shown in FIGS. 1 and 2) and an open position for loading and unloading articles into and from the dishwasher 100. In addition, as shown, a latch 116 may be used to lock and unlock the door 110 for access to the wash chamber 106.

As shown in FIG. 2, the dishwasher appliance 100 may be further equipped with a controller 156 to regulate operation of the dishwasher appliance 100. The controller 156 may include one or more memory devices and one or more microprocessors, such as general or special purpose microprocessors operable to execute programming instructions or micro-control code associated with a cleaning cycle. The memory may represent random access memory such as DRAM or read only memory such as ROM or FLASH. In an embodiment, the processor executes programming instructions stored in the memory. The memory may be a separate component from the processor or may be included onboard within the processor. Further, the controller 156 may be positioned in a variety of locations throughout the dishwasher appliance 100. In the illustrated embodiment, for example, the controller 156 may be located within a control panel area 158 of door 110 as shown in FIG. 1. Typically, the controller 156 includes a user interface panel/controls 160 through which a user may select various operational features and modes and monitor progress of the dishwasher appliance 100.

Referring particularly to FIG. 2, the dishwasher appliance 100 may further include a fluid reservoir 170 containing a plurality of fluids 178 for washing and/or rinsing the articles within the wash chamber 106. Furthermore, as shown, the dishwasher appliance 100 may also include a pump 174 for directing or pumping the plurality of fluids 178 from the fluid reservoir 170 and into the wash chamber 106. Further, and as will be discussed in more detail herein, the dishwasher appliance 100 may include a dispenser assembly 200 for controlling the plurality of fluids 178 flowing from the fluid reservoir 170 and into the wash chamber 106 along a flow path 172.

Thus, as shown in FIG. 2, the dispenser assembly 200 may be in fluid communication with a dispenser 176 in fluid communication with the dispenser assembly 200 for dispensing one of the plurality of different fluids into the wash chamber 106 at a time. As shown in FIG. 2, the fluid reservoir 170, the pump 174, the dispenser 176, and the dispenser assembly 200 may be disposed within the door 110. As such, FIG. 2 depicts the fluid reservoir 170, the dispenser assembly 200, the pump 174, and the dispenser 176 as having a particular arrangement along the flow path 172. However, it should be understood that such an arrangement is not limiting, and a variety of arrangements can be implemented in accordance with the present disclosure. For example, the pump 174 and the dispenser 176 can be arranged in a different order along the flow path 172 such that the dispenser 176 is disposed adjacent or connected to the dispenser assembly 200.

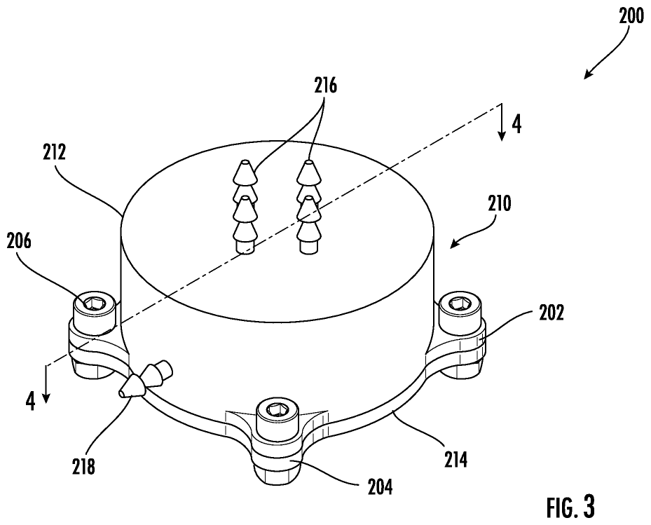

Referring now to FIG. 3, a perspective view of the dispenser assembly 200 according to an exemplary embodiment of the present disclosure is illustrated. The dispenser assembly 200 can be used with a variety of appliances, such as the dishwasher appliance 100 of FIGS. 1 and 2. As shown, the dispenser assembly 200 includes a housing 210 having a plurality of inlets 216 and an outlet 218. In an embodiment, the plurality of inlets 216 may extend from the housing 210 in a first direction, whereas the outlet 218 may extend from the housing 210 in a different, second direction. As such, in an embodiment, first and second directions may be generally perpendicular. Further, the plurality of inlets 216 may include any suitable number of inlets, such as four separate inlets as shown. In further embodiments, the dispenser assembly 200 can have more or less than four separate inlets.

Still referring to FIG. 3, the housing 210 of the dispenser assembly 200 may also have a first housing portion 212 detachably secured to a second housing portion 214. Further, in an embodiment, as shown, the first housing portion 212 and the second housing portion 214 can be secured together via one or more fasteners 206. In some embodiments, the fastener(s) 206 can include a variety of different fasteners, such as screws, nuts and bolts, or any other suitable fasteners. In addition, as shown, in an embodiment, the first housing portion 212 and the second housing portion 214 can each include a plurality of projections 202 and 204, respectively, for securing the first housing portion 212 with the second housing portion 214. For example, as shown, the plurality of projections 202, 204 of the first and second housing portions 212, 214 may be aligned and the fasteners 206 may extend therethrough.

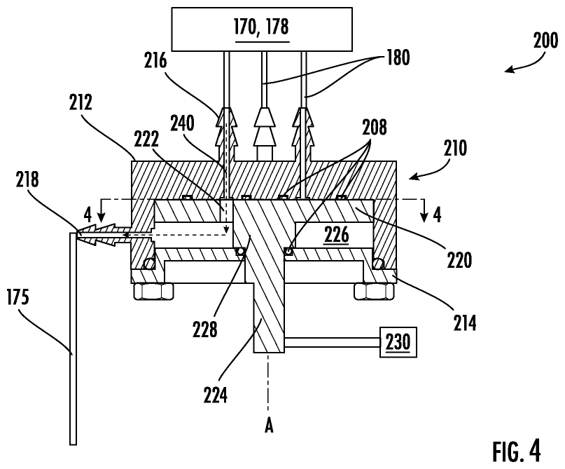

Referring now to FIG. 4, a cross-sectional view of the dispenser assembly 200 of FIG. 3 along line 4-4 is illustrated. As shown, the dispenser assembly 200 includes a rotatable disk 220 positioned within the housing 210. The rotatable disk 220 has an aperture 222 for being selectively aligned with one of the plurality of inlets 216 of the housing 210 to provide a flow path 240 between one of the plurality of inlets 216 and the outlet 218.

Further, as shown, a fluid volume 226 can be defined within the housing 210. For example, the fluid volume 226 can be defined between the first housing portion 312 and the second housing portion 214. In some embodiments, the fluid volume 226 can be defined between the second housing portion 214 and the rotatable disk 220. In such embodiments, the rotatable disk 220 includes protrusion 224 extending through the second housing portion 214 and beyond the housing 210. The rotatable disk 220 also includes a gauge section 228 formed between the protrusion 224 and the aperture 222 of the rotatable disk 220. As shown, the gauge section 228 does not extend through or beyond the second housing portion 214. Rather, the gauge section 228 the gauge section 228 is located inside the housing 210 and abuts the second housing portion 214. The gauge section 228 separates the aperture 222 of the rotatable disk 220 from the second housing portion 214 such that the fluid volume 226 is defined between the second housing portion 214 and the rotatable disk 220. Thus, as shown in FIG. 4, the flow path 240 passes through the fluid volume 226.

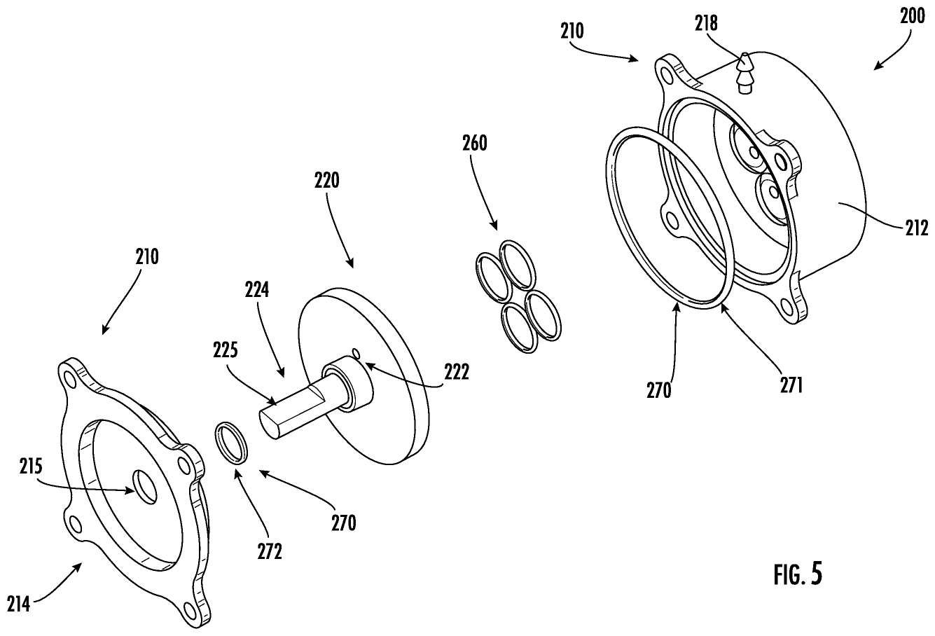

Referring to FIGS. 4 and 5, the rotatable disk 220 has the protrusion 224 extending through the second housing portion 214 and beyond the housing 210. Thus, in an embodiment, the protrusion 224 may be mechanically coupled to an actuator 230 for driving rotation of the rotatable disk 220 about axis A. As such, the actuator 230 shown in FIG. 4 drives the rotatable disk 220 about the axis A to align the aperture 222 of the rotatable disk 220 with one of the plurality of inlets 216. Moreover, in an embodiment, the protrusion 224 can have any suitable shape, such as a generally cylindrical shape. In particular, as shown in FIG. 5, the protrusion 224 may have a generally cylindrical shape with a flat surface 225. In such embodiments, the flat surface 225 of the protrusion 224 facilitates mechanical coupling with the actuator 230 for driving rotation of the rotatable disk 220.

In some embodiments, the dispenser assembly 200 is configured for being fluidly coupled with a fluid reservoir 170 containing a plurality of different fluids 178. In such embodiments, the dispenser assembly 200 is fluidly coupled with the fluid reservoir 170 (FIGS. 2 and 4) containing the plurality of fluids 178 via a plurality of conduits 180 coupled to the plurality of inlets 216 of the housing 210. Thus, in an embodiment, one of the plurality of fluids 178 can flow into the fluid volume 226 through one of the plurality of inlets 216 and fill the fluid volume 226. Further, the outlet 218 of the housing 210 is configured for being connected to a pump, such as the pump 174 of the dishwasher appliance 100 shown in FIG. 1, to be provided to the dispenser 176 of the dishwasher appliance 100. As shown in FIG. 4, a pump line 175 can be connected between the outlet 218 of the housing 210 and the pump 174 of the dishwasher appliance 100 for the different fluids 178 to be pumped therethrough. As such, in an embodiment, the dispenser 176 can be configured for dispensing one of the plurality of different fluids 178 into the appliance at a time.

Referring still to FIGS. 4 and 5, the dispenser assembly 200 may also include at least one inlet seal 260 within the housing 210 for fluidly separating each of the plurality of inlets 216. The dispenser assembly 200 also includes at least one housing seal 270. The housing seal 270 can be arranged between the first housing portion 212 and the second housing portion 214 and/or the protrusion 224 of the rotatable disk 220 and the second housing portion 214. In particular, a first housing seal 271 can be arranged between the first and second housings portions 212, 214, and a second housing seal 272 can be arranged between the protrusion 224 and the second housing portion 214. Further, as shown, the second housing portion 214 can define an opening 215 for the protrusion 224 to extend therethrough.

In addition, as shown generally in FIGS. 4 and 5, the dispenser assembly 200 may include spaces and/or gaps between certain features to facilitate operation thereof. For example, as shown in FIG. 4, a plurality of recesses 208 are formed into at least one of the first housing portion 212 and the second housing portion 214. More specifically, one or more of the recesses can be formed between the first housing portion 212 and the rotating disk 220. Additionally, one or more of the recesses 208 can be formed between the first housing portion 212 and the second housing portion 214. Furthermore, one of more of the recesses 208 can be formed between the rotating disk 220 and the second housing portion 214. In such embodiments, the at least one inlet seal 260 and/or the at least one housing seal 270 fits within the one or more recesses 208, such as the one or more recesses formed into at least one of the first housing portion 212 or the second housing portion 214.

For example, the at least one inlet seal 260 can fit within the one or more recesses 208 formed between the first housing portion 212 and the rotating disk 220. The at least one housing seal 270 can fit within the one or more recesses 208 formed between the first housing portion 212 and the second housing portion 214 or the one or more recesses 208 formed between the second housing portion 214 and the rotating disk 220. In particular, the first housing seal 271 can fit within the recess 208 formed between the first and second housing portions 212, 214, while the second housing seal 272 can fit within the recess 208 between the second housing portion 214 and the rotating disk 220. In certain embodiments, as shown in FIG. 5, for example, the inlet seal(s) 260 and/or the housing seal(s) 270 can include one or more O-rings.

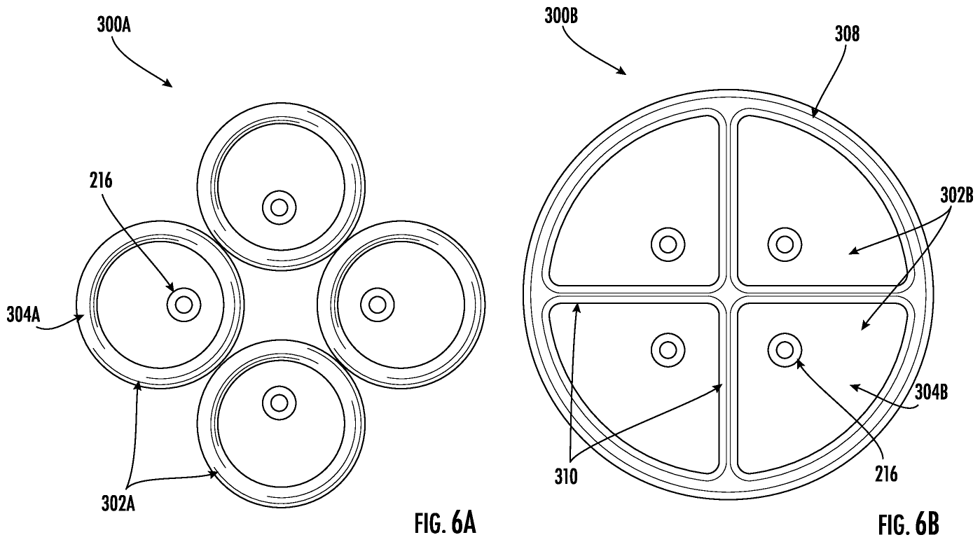

Referring to FIGS. 6A-6B, further embodiments of the inlet seal(s) 360 of the dispenser assembly 200 are illustrated according to the present disclosure. For instance, in an embodiment, FIG. 6A provides a multi-seal arrangement 300A of the inlet seal 260. In particular, as shown, the multi-seal arrangement 300A has a plurality of inlet seals 302A with one of the plurality of inlet seals 302A being arranged with each of the plurality of inlets 216. As shown, the plurality of inlet seals 302A includes a first inlet seal 304A arranged with one of the plurality of inlets 216. In this regard, the plurality of inlet seals 302A includes a number of inlet seals that is equivalent to a number of each inlet of the plurality of inlets 216.

Moreover, in another embodiment, FIG. 6B illustrates a segmented-ring seal 300B of the inlet seal 260. In such embodiments, the segmented-ring seal 300B is a single inlet seal that defines a plurality of openings 302B. One of the plurality of openings 302B is arranged with each of the plurality of inlets 216. As shown in FIG. 6B, the second inlet seal includes a ring 408 and a plurality of cross-connecting segments 410, thereby defining the plurality of openings 302B. The plurality of openings 302B includes a first opening 304B arranged with one of the plurality of inlets 216. In this regard, the plurality of openings 302B comprises a number of openings that is equivalent to a number of each inlet of the plurality of inlets 216.

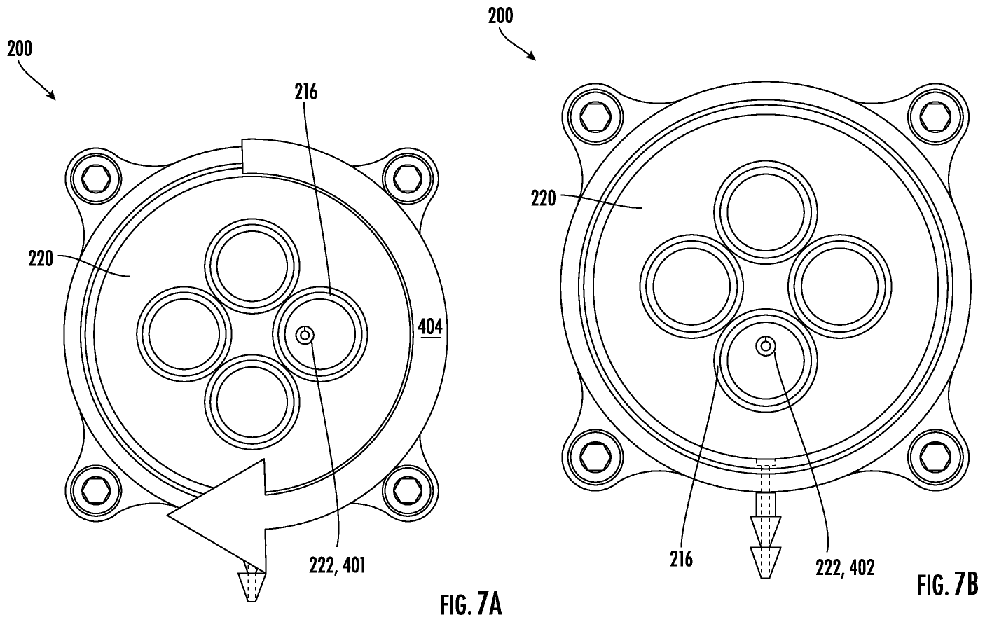

Referring now to FIGS. 7A-7B, cross-sectional views of different positions of the dispenser assembly 200 of FIG. 3 are illustrated according to the present disclosure. Specifically, the cross-sectional views depicted in FIGS. 7A-7B are described herein with further reference to FIGS. 1-5 and 6A-6B. Further, in FIGS. 7A-7B, the cross-sectional views are taken along the line 4-4 shown in FIG. 4. As such, the dispenser assembly 200 includes the rotatable disk 220 with the aperture 222 and the inlet seal 260 disposed between the rotatable disk 220 and the first housing portion 212. Referring particularly to FIG. 7A, the aperture 222 of the rotatable disk 220 can be in a first position 401. In the first position 401, the aperture 222 is selectively aligned with an inlet of the plurality of inlets 216 to provide a flow path 240 between the an inlet of the plurality of inlets 216 and the outlet 218 of the housing 210. In the first position 401, the remaining inlets of the plurality of inlets 216 are blocked by the rotatable disk 220 while allowing the one inlet to facilitate releasing one of the plurality of fluids 178 contained within the fluid reservoir 170. The actuator 230 of the dispenser assembly 200 is configured to drive rotation of the rotatable disk 220 about the axis A. As such, the rotatable disk 220 can be rotated in a rotational direction 404 such that that aperture is no longer in the first position 401.

As shown in FIG. 7B, the rotatable disk 220 is rotated such that the aperture 222 is in a second position 402. In the second position 402, the aperture 222 is selectively aligned with a different inlet of the plurality of inlets 216 to provide a flow path 240 between the different inlet of the plurality of inlets 216 and the outlet 218 of the housing 210.

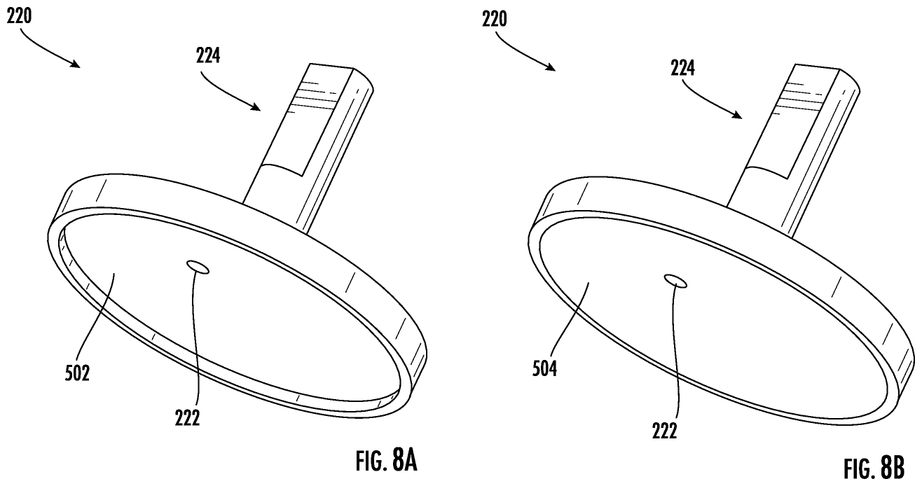

FIGS. 8A-8B provide alternative embodiments of a coating for a rotatable disk 220 of the dispenser assembly 200 of FIG. 3. As further described in FIGS. 4-6, the dispenser assembly 200 is shown in FIGS. 8A-8B and includes the protrusion 224 and the aperture 222. Additionally, as shown in FIG. 8A, the rotatable disk 220 defines a surface 502. When the rotatable disk 220 is positioned within the housing 210, the surface 502 is arranged adjacent to the plurality of inlets 216. The surface 502 can be formed of any material suitable for use with the dispenser assembly 200. In addition and referring to FIG. 8B, the rotatable disk 220 may include one or more additional layers 504 of material for reducing friction between the rotatable disk 220 and the first housing portion 212. In certain embodiments, for example, the additional layer(s) 504 of material may be a coating material, surface finish, or any material that is molded (e.g., over-molded) onto the surface 502 of the rotatable disk 220 so as to reduce friction. The additional layer(s) 504 of material may be applied to the surface 502 using any suitable means, such as via painting, coating, bonding, additive manufacturing, press-fitting, etc. In such embodiments, the additional layer(s) 504 of material may facilitate rotation of the rotatable disk by reducing friction between the rotatable disk 220 and the first housing portion 212.

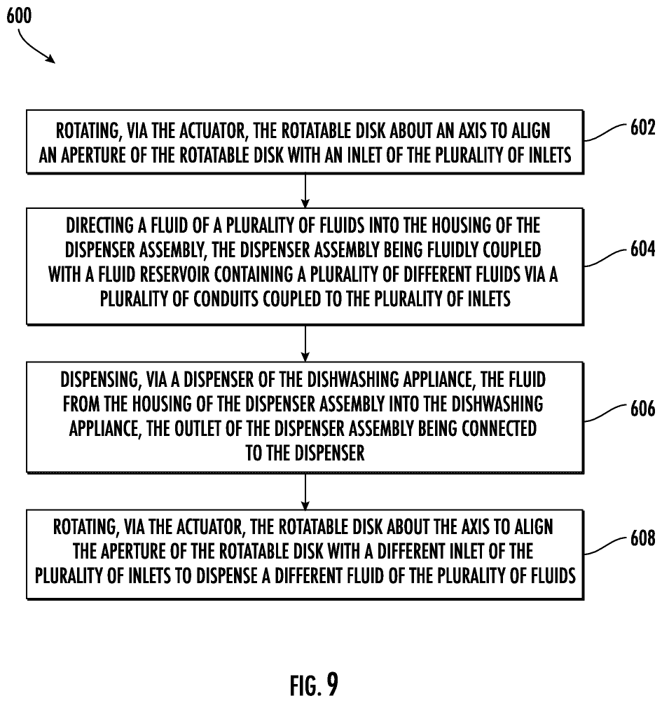

Referring now to FIG. 9, a method 600 for operating a dispenser assembly, such as the dispenser assembly 200 described herein, in accordance with an embodiment of the present disclosure is illustrated. In general, the method 600 will be described herein with reference to the dispenser assembly 200 described herein. However, it should be appreciated that the disclosed method 600 may be implemented with any dispenser assembly having any other suitable configurations. In addition, although FIG. 9 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (602), the method 600 includes rotating, via an actuator, a rotatable disk of a dispenser assembly to align an aperture of the rotatable disk with an inlet of a plurality of inlets. For example, according to an embodiment, the rotatable disk 220 of the dispenser assembly 200 may be rotated, via the actuator 230, about the axis A to align the aperture 222 of the rotatable disk 220 with an inlet of the plurality of inlets 216. As shown at (604), the method 600 includes directing a fluid of a plurality of fluids into the housing of the dispenser assembly, the dispenser assembly being fluidly coupled with a fluid reservoir containing a plurality of different fluids via a plurality of conduits coupled to the plurality of inlets. As explained above, the fluid reservoir 170 contains the plurality of fluids 178. Thus, one of the plurality of fluids 178 can be transferred, e.g., via the pump 174, from the fluid reservoir 170 into the housing 210 of the dispenser assembly 200. The dispenser assembly 200 is fluidly coupled, via the plurality of conduits 180, with the fluid reservoir 170 containing the plurality of different fluids 178.

As shown at (606), the method 600 includes dispensing, via a dispenser of the dishwashing appliance, the fluid from the housing of the dispenser assembly into the dishwashing appliance, the outlet of the dispenser assembly being connected to the dispenser. For example, according to an embodiment, one of the plurality of fluids 178 can be dispensed, via the dispenser 176, into the dishwasher appliance 100. The outlet 218 of the dispenser assembly 200 is connected to the dispenser 176. More particularly, the plurality of fluids 178 can be pumped, via the pump 174, from the fluid volume 226 defined by the housing 210 to the dispenser 176, which is configured to dispense the plurality of fluids 178. As shown at (608), the method 600 includes rotating, via the actuator, the rotatable disk about the axis to align the aperture of the rotatable disk with a different inlet of the plurality of inlets to dispense a different fluid of the plurality of fluids. As explained above, the rotatable disk 220 can be rotated, via the actuator 230, about the axis A to align the aperture 222 of the rotatable disk 220 with a different inlet of the plurality of inlets 216 to dispense a different fluid of the plurality of fluids 178.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dispenser assembly for an appliance, the dispenser assembly comprising:
a housing comprising a plurality of inlets and an outlet;
a rotatable disk positioned within the housing, the rotatable disk comprising an aperture for being selectively aligned with one of the plurality of inlets to provide a flow path between one of the plurality of inlets and the outlet; and
an actuator mechanically coupled to the rotatable disk for driving rotation of the rotatable disk about an axis to align the aperture of the rotatable disk with one of the plurality of inlets.

2. The dispenser assembly of claim 1, further comprising at least one inlet seal within the housing for fluidly separating each of the plurality of inlets.

3. The dispenser assembly of claim 2, wherein the at least one inlet seal comprises a plurality of inlet seals, with one of the plurality of inlet seals being arranged with each of the plurality of inlets.

4. The dispenser assembly of claim 2, wherein the at least one inlet seal comprises a single inlet seal defining a plurality of openings, with one of the plurality of openings arranged with each of the plurality of inlets.

5. The dispenser assembly of claim 2, wherein the housing comprises a first housing portion detachably secured to a second housing portion.

6. The dispenser assembly of claim 5, wherein the first and second housing portions are secured together via one or more fasteners.

7. The dispenser assembly of claim 5, wherein the rotatable disk comprises a protrusion extending through the second housing portion and beyond the housing, the protrusion being mechanically coupled to the actuator.

8. The dispenser assembly of claim 7, further comprising at least one housing seal arranged between at least one of the first and second housing portions or the protrusion of the rotatable disk and the second housing portion.

9. The dispenser assembly of claim 8, wherein the at least one inlet seal and/or the at least one housing seal comprises an O-ring.

10. The dispenser assembly of claim 8, wherein the at least one inlet seal and/or the at least one housing seal fits within one or more recesses formed into at least one of the first housing portion or the second housing portion.

11. The dispenser assembly of claim 1, wherein the dispenser assembly is configured for being fluidly coupled with a fluid reservoir containing a plurality of different fluids via a plurality of conduits coupled to the plurality of inlets.

12. The dispenser assembly of claim 11, wherein the outlet is configured for being connected to a dispenser of the appliance for dispensing one of the plurality of different fluids into the appliance at a time.

13. The dispenser assembly of claim 1, wherein the rotatable disk defines a surface arranged adjacent to the plurality of inlets, the surface comprising one or more additional layers for reducing friction.

14. The dispenser assembly of claim 1, wherein the appliance is a dishwashing appliance.

15. A dishwashing appliance, comprising:
a wash chamber for receipt of articles for washing;
a door for selectively opening and closing the wash chamber;
a fluid reservoir containing a plurality of different fluids;
a pump for directing the plurality of fluids to flow from the fluid reservoir to the wash chamber;
a dispenser assembly, the dispenser assembly comprising:
a housing comprising a plurality of inlets and an outlet;
a rotatable disk positioned within the housing, the rotatable disk comprising an aperture for being selectively aligned with one of the plurality of inlets to provide a flow path between one of the plurality of inlets and the outlet; and
an actuator mechanically coupled to the rotatable disk for driving rotation of the rotatable disk about an axis to align the aperture of the rotatable disk with one of the plurality of inlets; and
a dispenser connected to the outlet for dispensing one of the plurality of different fluids into the appliance at a time.

16. The dishwashing appliance of claim 15, wherein the housing of the dispenser assembly comprises a first housing portion detachably secured to a second housing portion via one or more fasteners.

17. The dishwashing appliance of claim 16, wherein the rotatable disk comprises a protrusion extending through the second housing portion and beyond the housing, the protrusion being mechanically coupled to the actuator.

18. The dishwashing appliance of claim 17, wherein the dispenser assembly further comprises:
at least one inlet seal within the housing for fluidly separately each of the plurality of inlets; and
at least one housing seal arranged between at least one of the first housing portion and the second housing portion or the protrusion of the rotatable disk and the second housing portion,
wherein the at least one inlet seal and/or the at least one housing seal comprises an O-ring.

19. The dishwashing appliance of claim 15, wherein the dispenser assembly is configured for being fluidly coupled with the fluid reservoir via a plurality of conduits coupled to the plurality of inlets.

20. A method for operating a dishwashing appliance comprising a dispenser assembly, the dispenser assembly comprising a housing having a plurality of inlets and an outlet, a rotatable disk positioned within the housing, and an actuator mechanically coupled to the rotatable disk for driving rotation of the rotatable disk, the method comprising:
rotating, via the actuator, the rotatable disk about an axis to align an aperture of the rotatable disk with an inlet of the plurality of inlets;
directing a fluid of a plurality of fluids into the housing of the dispenser assembly, the dispenser assembly being fluidly coupled with a fluid reservoir containing a plurality of different fluids via a plurality of conduits coupled to the plurality of inlets;
dispensing, via a dispenser of the dishwashing appliance, the fluid from the housing of the dispenser assembly into the dishwashing appliance, the outlet of the dispenser assembly being connected to the dispenser; and
rotating, via the actuator, the rotatable disk about the axis to align the aperture of the rotatable disk with a different inlet of the plurality of inlets to dispense a different fluid of the plurality of fluids.
